(19) United States
(12) Patent Application Publication
(10) Pub. No.: US 2026/0258688 A1
(43) Pub. Date: Sep. 3, 2026

(54) VEHICLE WITH PORT ENCLOSURE

(71) Applicant: Oshkosh Corporation, Oshkosh, WI (US)

(72) Inventors: Brandon Lemke, Oshkosh, WI (US); Jon Zeamer, Oshkosh, WI (US); Michael Moore, Oshkosh, WI (US); Greg Steffens, Oshkosh, WI (US); Jeff Verhagen, Oshkosh, WI (US); McCall Groen, Oshkosh, WI (US)

(73) Assignee: Oshkosh Corporation, Oshkosh, WI (US)

(21) Appl. No.: 19/652,705

(22) Filed: Apr. 20, 2026

Related U.S. Application Data
(63) Continuation of application No. 18/171,155, filed on Feb. 17, 2023, now abandoned.
(60) Provisional application No. 63/325,941, filed on Mar. 31, 2022.

(51) Int. Cl. E05F 15/53; B60K 1/04; B60L 1/00; B60L 53/16; B60P 1/50; B62D 33/06; E05F 5/06

(52) U.S. Cl. CPC E05F 15/53; B60K 1/04; B60L 1/00; B60L 53/16; B60P 1/50; B62D 33/06; E05F 5/06

(57) ABSTRACT

A vehicle includes a chassis, a body coupled to the chassis and having a front surface, the body defining a recess positioned along the front surface and extending rearward from the front surface, a port coupled to the body and positioned within the recess, and a door movably coupled to the body and selectively repositionable between a closed position and an open position. In the closed position, the door extends across the recess and obstructs access to the port. In the open position, the door permits access to the port.

### CROSS-REFERENCE TO RELATED PATENT APPLICATION

This application is a continuation of U.S. patent application Ser. No. 18/171,155, filed Feb. 17, 2023, which claims the benefit of and priority to U.S. Provisional Application No. 63/325,941, filed on Mar. 31, 2022, the entire disclosures of each of which are hereby incorporated by reference herein.

### BACKGROUND

The present disclosure relates generally to vehicles. More specifically, the present disclosure relates to vehicles having ports to connect the vehicles to external systems.

### SUMMARY

One embodiment relates to a vehicle. The vehicle includes a chassis, a body coupled to the chassis and having a front surface, the body defining a recess positioned along the front surface and extending rearward from the front surface, a port coupled to the body and positioned within the recess, and a door movably coupled to the body and selectively repositionable between a closed position and an open position. In the closed position, the door extends across the recess and obstructs access to the port. In the open position, the door permits access to the port.

Another embodiment relates to a port enclosure. The port enclosure includes a body member defining a recess, a door pivotally coupled to the body member and selectively repositionable between a closed position, an open position, and a middle position between the closed position and the open position, and a compression spring pivotally coupled to the door and the body member. The compression spring is configured to bias the door toward the closed position when the door is between the middle position and the closed position. The compression spring is configured to bias the door toward the open position when the door is between the middle position and the open position.

Another embodiment relates to a refuse vehicle. The refuse vehicle includes a chassis and a body coupled to the chassis. The body includes a refuse compartment and a cabin configured to contain an operator. The body defining a recess extending inward from an outer surface of the body. The refuse vehicle further includes a lift assembly coupled to the chassis and configured to transfer refuse from a refuse container into the refuse compartment, a battery coupled to the chassis and configured to supply electrical energy to power the lift assembly, a charging port electrically coupled to the battery and configured to selectively couple to an external power source to charge the battery, the charging port being positioned within the recess, a door pivotally coupled to the body and selectively repositionable through a range of motion extending between a closed position and an open position, and a biasing member coupled to the door and the body. The biasing member is configured to bias the door toward the open position when the door is in a first portion of the range of motion. The biasing member is configured to bias the door toward the closed position when the door is in a second portion of the range of motion.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a left side view of a vehicle, according to an exemplary embodiment.

FIG. 2 is a perspective view of a chassis of the vehicle of FIG. 1.

FIG. 3 is a perspective view of the vehicle of FIG. 1 configured as a front-loading refuse vehicle, according to an exemplary embodiment.

FIG. 4 is a left side view of the front-loading refuse vehicle of FIG. 3 configured with a tag axle.

FIG. 5 is a perspective view of the vehicle of FIG. 1 configured as a side-loading refuse vehicle, according to an exemplary embodiment.

FIG. 6 is a right side view of the side-loading refuse vehicle of FIG. 5.

FIG. 7 is a top view of the side-loading refuse vehicle of FIG. 5.

FIG. 8 is a left side view of the side-loading refuse vehicle of FIG. 5 configured with a tag axle.

FIG. 9 is a perspective view of the vehicle of FIG. 1 configured as a mixer vehicle, according to an exemplary embodiment.

FIG. 10 is a perspective view of the vehicle of FIG. 1 configured as a fire fighting vehicle, according to an exemplary embodiment.

FIG. 11 is a left side view of the vehicle of FIG. 1 configured as an airport fire fighting vehicle, according to an exemplary embodiment.

FIG. 12 is a perspective view of the vehicle of FIG. 1 configured as a boom lift, according to an exemplary embodiment.

FIG. 13 is a perspective view of the vehicle of FIG. 1 configured as a scissor lift, according to an exemplary embodiment.

FIG. 14 is a front view of the vehicle of FIG. 1, shown with a door of a port enclosure in a closed position, according to an exemplary embodiment.

FIG. 15 is a front perspective view of the vehicle of FIG. 14, shown with the door in a charging position.

FIG. 16 is a front perspective view of the vehicle of FIG. 14, shown with the door in an open position.

FIG. 17 is a left side view of the vehicle of FIG. 14, shown with a charging connector engaged with the charging port and the door in the charging position, according to an exemplary embodiment.

FIG. 18 is a left side section view of the vehicle of FIG. 14 with the door in the closed position.

FIG. 19 is a left side section view of the vehicle of FIG. 14 with the door in the charging position.

FIG. 20 is a left side section view of the vehicle of FIG. 14 with the door in the open position.

FIG. 21 is a front view of the vehicle of FIG. 1 with a port enclosure, according to an alternative embodiment.

FIG. 22 is another front view of the vehicle of FIG. 21.

FIG. 23 is a front perspective view of the vehicle of FIG. 21.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a vehicle includes a front body having a front bumper assembly. The front bumper assembly includes at least a charging port. The charging port includes a port door, one or more hinges coupled to the port door, and one or more gas springs coupled to the one or more hinges. The port door is repositionable between a closed position, a charging position or middle position, and an open position. The hinges define a concave structure extending inward toward the vehicle. The concave structure allows a portion of the bumper assembly to be at least partially received within the concave portion when the port door rotates out of the closed position. The gas spring provides both an outward and an inward bias on the hinge when repositioning the port door between at least the closed position and the open position.

In some embodiments, the charging port includes a stop that is configured to engage the hinge when the port door is in the charging position. The stop may be one of a protrusion, detent, magnet, or the like.

### Overall Vehicle

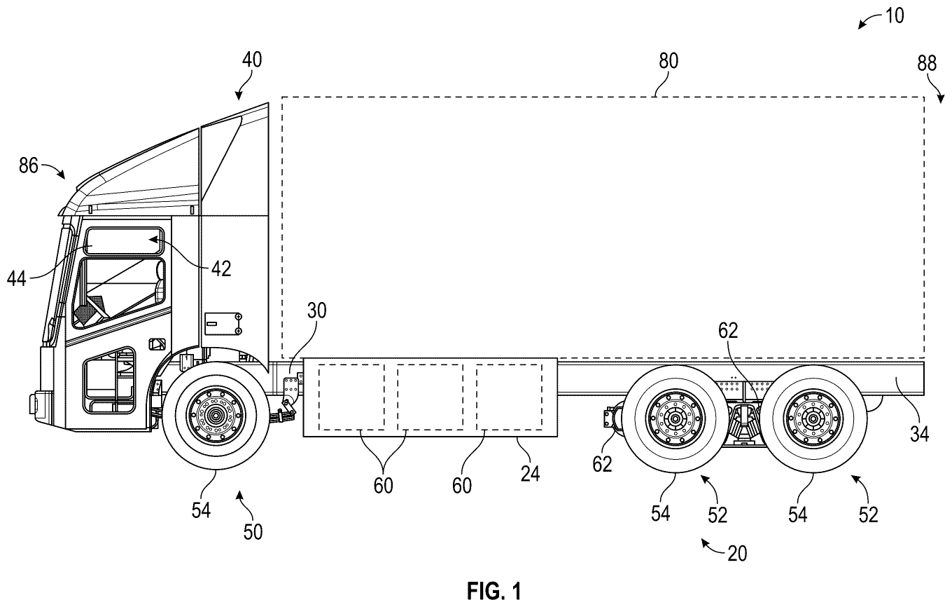

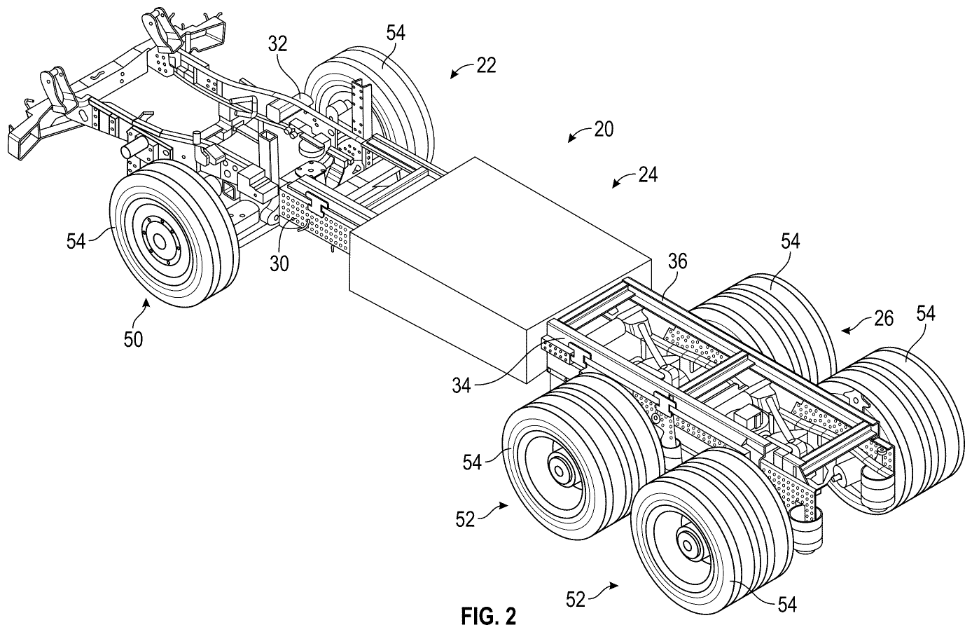

Referring to FIGS. 1 and 2, a reconfigurable vehicle (e.g., a vehicle assembly, a truck, a vehicle base, etc.) is shown as vehicle 10, according to an exemplary embodiment. As shown, the vehicle 10 includes a frame assembly or chassis assembly, shown as chassis 20, that supports other components of the vehicle 10. The chassis 20 extends longitudinally along a length of the vehicle 10, substantially parallel to a primary direction of travel of the vehicle 10. As shown, the chassis 20 includes three sections or portions, shown as front section 22, middle section 24, and rear section 26. The middle section 24 of the chassis 20 extends between the front section 22 and the rear section 26. In some embodiments, the middle section 24 of the chassis 20 couples the front section 22 to the rear section 26. In other embodiments, the front section 22 is coupled to the rear section 26 by another component (e.g., the body of the vehicle 10).

As shown in FIG. 2, the front section 22 includes a pair of frame portions, frame members, or frame rails, shown as front rail portion 30 and front rail portion 32. The rear section 26 includes a pair of frame portions, frame members, or frame rails, shown as rear rail portion 34 and rear rail portion 36. The front rail portion 30 is laterally offset from the front rail portion 32. Similarly, the rear rail portion 34 is laterally offset from the rear rail portion 36. This spacing may provide frame stiffness and space for vehicle components (e.g., batteries, motors, axles, gears, etc.) between the frame rails. In some embodiments, the front rail portions 30 and 32 and the rear rail portions 34 and 36 extend longitudinally and substantially parallel to one another. The chassis 20 may include additional structural elements (e.g., cross members that extend between and couple the frame rails).

In some embodiments, the front section 22 and the rear section 26 are configured as separate, discrete subframes (e.g., a front subframe and a rear subframe). In such embodiments, the front rail portion 30, the front rail portion 32, the rear rail portion 34, and the rear rail portion 36 are separate, discrete frame rails that are spaced apart from one another. In some embodiments, the front section 22 and the rear section 26 are each directly coupled to the middle section 24 such that the middle section 24 couples the front section 22 to the rear section 26. Accordingly, the middle section 24 may include a structural housing or frame. In other embodiments, the front section 22, the middle section 24, and the rear section 26 are coupled to one another by another component, such as a body of the vehicle 10.

In other embodiments, the front section 22, the middle section 24, and the rear section 26 are defined by a pair of frame rails that extend continuously along the entire length of the vehicle 10. In such an embodiment, the front rail portion 30 and the rear rail portion 34 would be front and rear portions of a first frame rail, and the front rail portion 32 and the rear rail portion 36 would be front and rear portions of a second frame rail. In such embodiments, the middle section 24 would include a center portion of each frame rail.

In some embodiments, the middle section 24 acts as a storage portion that includes one or more vehicle components. The middle section 24 may include an enclosure that contains one or more vehicle components and/or a frame that supports one or more vehicle components. By way of example, the middle section 24 may contain or include one or more electrical energy storage devices (e.g., batteries, capacitors, etc.). By way of another example, the middle section 24 may include fuel tanks. By way of yet another example, the middle section 24 may define a void space or storage volume that can be filled by a user.

A cabin, operator compartment, or body component, shown as cab 40, is coupled to a front end portion of the chassis 20 (e.g., the front section 22 of the chassis 20). Together, the chassis 20 and the cab 40 define a front end of the vehicle 10. The cab 40 extends above the chassis 20. The cab 40 includes an enclosure or main body that defines an interior volume, shown as cab interior 42, that is sized to contain one or more operators. The cab 40 also includes one or more doors 44 that facilitate selective access to the cab interior 42 from outside of the vehicle 10. The cab interior 42 contains one or more components that facilitate operation of the vehicle 10 by the operator. By way of example, the cab interior 42 may contain components that facilitate operator comfort (e.g., seats, seatbelts, etc.), user interface components that receive inputs from the operators (e.g., steering wheels, pedals, touch screens, switches, buttons, levers, etc.), and/or user interface components that provide information to the operators (e.g., lights, gauges, speakers, etc.). The user interface components within the cab 40 may facilitate operator control over the drive components of the vehicle 10 and/or over any implements of the vehicle 10.

The vehicle 10 further includes a series of axle assemblies, shown as front axle 50 and rear axles 52. As shown, the vehicle 10 includes one front axle 50 coupled to the front section 22 of the chassis 20 and two rear axles 52 each coupled to the rear section 26 of the chassis 20. In other embodiments, the vehicle 10 includes more or fewer axles. By way of example, the vehicle 10 may include a tag axle that may be raised or lowered to accommodate variations in weight being carried by the vehicle 10. The front axle 50 and the rear axles 52 each include a series of tractive elements (e.g., wheels, treads, etc.), shown as wheel and tire assemblies 54. The wheel and tire assemblies 54 are configured to engage a support surface (e.g., roads, the ground, etc.) to support and propel the vehicle 10. The front axle 50 and the rear axles 52 may include steering components (e.g., steering arms, steering actuators, etc.), suspension components (e.g., gas springs, dampeners, air springs, etc.), power transmission or drive components (e.g., differentials, drive shafts, etc.), braking components (e.g., brake actuators, brake pads, brake discs, brake drums, etc.), and/or other components that facilitate propulsion or support of the vehicle.

In some embodiments, the vehicle 10 is configured as an electric vehicle that is propelled by an electric powertrain system. Referring to FIG. 1, the vehicle 10 includes one or more electrical energy storage devices (e.g., batteries, capacitors, etc.), shown as batteries 60. As shown, the batteries 60 are positioned within the middle section 24 of the chassis 20. In other embodiments, the batteries 60 are otherwise positioned throughout the vehicle 10. The vehicle 10 further includes one or more electromagnetic devices or prime movers (e.g., motor/generators), shown as drive motors 62. The drive motors 62 are electrically coupled to the batteries 60. The drive motors 62 may be configured to receive electrical energy from the batteries 60 and provide rotational mechanical energy to the wheel and tire assemblies 54 to propel the vehicle 10. The drive motors 62 may be configured to receive rotational mechanical energy from the wheel and tire assemblies 64 and provide electrical energy to the batteries 60, providing a braking force to slow the vehicle 10.

The batteries 60 may include one or more rechargeable batteries (e.g., lithium-ion batteries, nickel-metal hydride batteries, lithium-ion polymer batteries, lead-acid batteries, nickel-cadmium batteries, etc.). The batteries 60 may be charged by one or more sources of electrical energy onboard the vehicle 10 (e.g., solar panels, etc.) or separate from the vehicle 10 (e.g., connections to an electrical power grid, a wireless charging system, etc.). As shown, the drive motors 62 are positioned within the rear axles 52 (e.g., as part of a combined axle and motor assembly). In other embodiments, the drive motors 62 are otherwise positioned within the vehicle 10.

In other embodiments, the vehicle 10 is configured as a hybrid vehicle that is propelled by a hybrid powertrain system (e.g., a diesel/electric hybrid, gasoline/electric hybrid, natural gas/electric hybrid, etc.). According to an exemplary embodiment, the hybrid powertrain system may include a primary driver (e.g., an engine, a motor, etc.), an energy generation device (e.g., a generator, etc.), and/or an energy storage device (e.g., a battery, capacitors, ultra-capacitors, etc.) electrically coupled to the energy generation device. The primary driver may combust fuel (e.g., gasoline, diesel, etc.) to provide mechanical energy, which a transmission may receive and provide to the front axle 50 and/or the rear axles 52 to propel the vehicle 10. Additionally or alternatively, the primary driver may provide mechanical energy to the generator, which converts the mechanical energy into electrical energy. The electrical energy may be stored in the energy storage device (e.g., the batteries 60) in order to later be provided to a motive driver.

In yet other embodiments, the chassis 20 may further be configured to support non-hybrid powertrains. For example, the powertrain system may include a primary driver that is a compression-ignition internal combustion engine that utilizes diesel fuel.

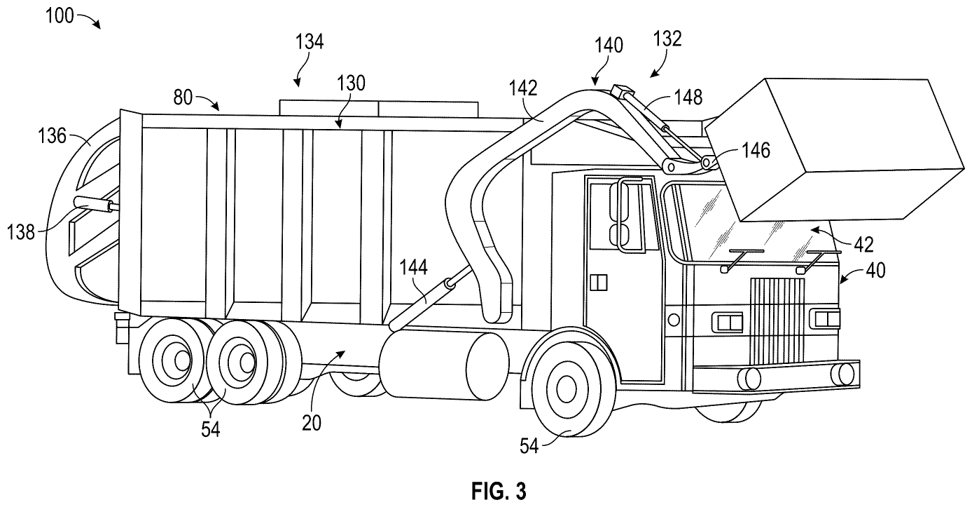

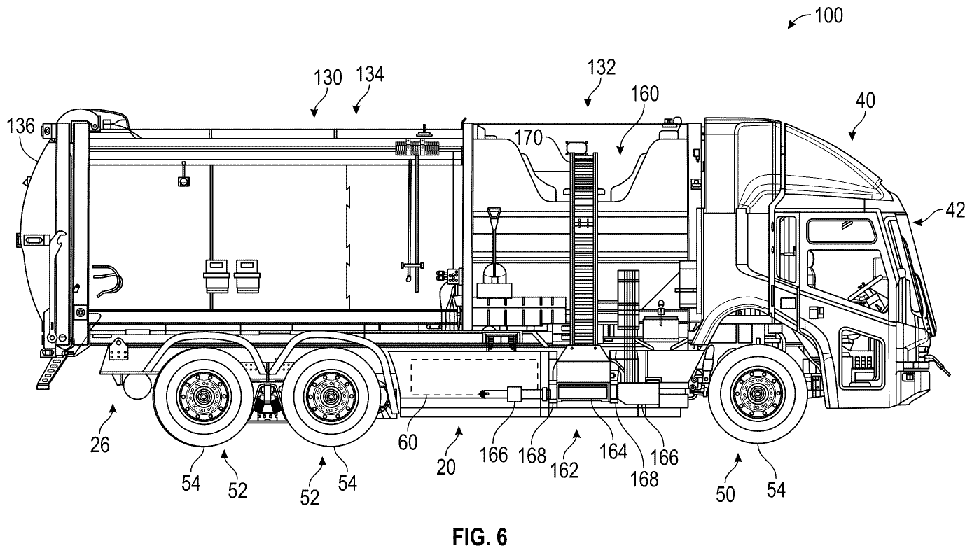

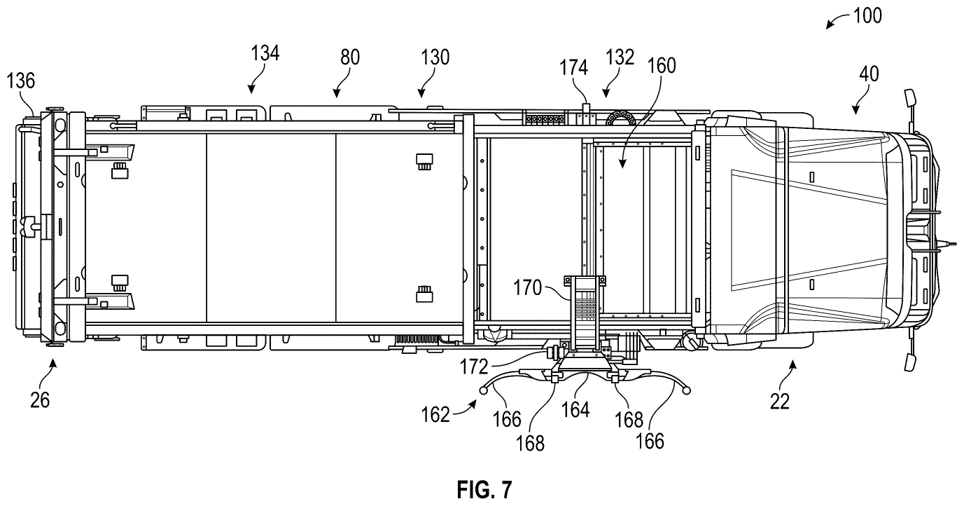

Referring to FIG. 1, the vehicle 10 includes a rear assembly, module, implement, body, or cargo area, shown as application kit 80. The application kit 80 may include one or more implements, vehicle bodies, and/or other components. Although the application kit 80 is shown positioned behind the cab 40, in other embodiments the application kit 80 extends forward of the cab 40. The vehicle 10 may be outfitted with a variety of different application kits 80 to configure the vehicle 10 for use in different applications. Accordingly, a common vehicle 10 can be configured for a variety of different uses simply by selecting an appropriate application kit 80. By way of example, the vehicle 10 may be configured as a refuse vehicle, a concrete mixer, a fire fighting vehicle, an airport fire fighting vehicle, a lift device (e.g., a boom lift, a scissor lift, a telehandler, a vertical lift, etc.), a crane, a tow truck, a military vehicle, a delivery vehicle, a mail vehicle, a boom truck, a plow truck, a farming machine or vehicle, a construction machine or vehicle, a coach bus, a school bus, a semi-truck, a passenger or work vehicle (e.g., a sedan, a SUV, a truck, a van, etc.), and/or still another vehicle. FIGS. 3-13 illustrate various examples of how the vehicle 10 may be configured for specific applications. Although only a certain set of vehicle configurations is shown, it should be understood that the vehicle 10 may be configured for use in other applications that are not shown.

The application kit 80 may include various actuators to facilitate certain functions of the vehicle 10. By way of example, the application kit 80 may include hydraulic actuators (e.g., hydraulic cylinders, hydraulic motors, etc.), pneumatic actuators (e.g., pneumatic cylinders, pneumatic motors, etc.), and/or electrical actuators (e.g., electric motors, electric linear actuators, etc.). The application kit 80 may include components that facilitate operation of and/or control of these actuators. By way of example, the application kit 80 may include hydraulic or pneumatic components that form a hydraulic or pneumatic circuit (e.g., conduits, valves, pumps, compressors, gauges, reservoirs, accumulators, etc.). By way of another example, the application kit 80 may include electrical components (e.g., batteries, capacitors, voltage regulators, motor controllers, etc.). The actuators may be powered by components of the vehicle 10. By way of example, the actuators may be powered by the batteries 60, the drive motors 62, or the primary driver (e.g., through a power take off).

The vehicle 10 generally extends longitudinally from a front side 86 to a rear side 88. The front side 86 is defined by the cab 40 and/or the chassis. The rear side 88 is defined by the application kit 80 and/or the chassis 20. The primary, forward direction of travel of the vehicle 10 is longitudinal, with the front side 86 being arranged forward of the rear side 88.

### A. Front-loading Refuse Vehicle

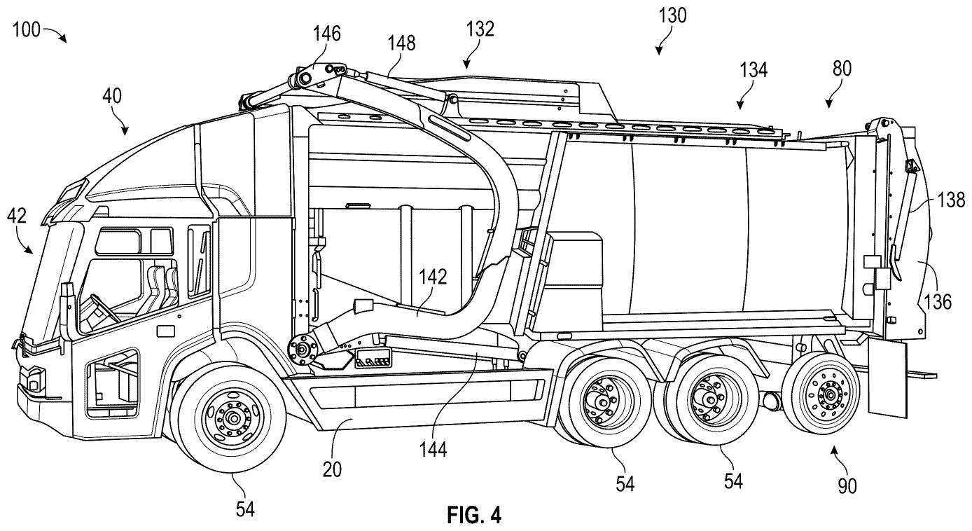

Referring now to FIGS. 3 and 4, the vehicle 10 is configured as a refuse vehicle 100 (e.g., a refuse truck, a garbage truck, a waste collection truck, a sanitation truck, a recycling truck, etc.). Specifically, the refuse vehicle 100 is a front-loading refuse vehicle. In other embodiments, the refuse vehicle 100 is configured as a rear-loading refuse vehicle or a front-loading refuse vehicle. The refuse vehicle 100 may be configured to transport refuse from various waste receptacles (e.g., refuse containers) within a municipality to a storage and/or processing facility (e.g., a landfill, an incineration facility, a recycling facility, etc.).

FIG. 4 illustrates the refuse vehicle 100 of FIG. 3 configured with a liftable axle, shown as tag axle 90, including a pair of wheel and tire assemblies 54. As shown, the tag axle 90 is positioned reward of the rear axles 52. The tag axle 90 can be selectively raised and lowered (e.g., by a hydraulic actuator) to selectively engage the wheel and tire assemblies 54 of the tag axle 90 with the ground. The tag axle 90 may be raised to reduce rolling resistance experienced by the refuse vehicle 100. The tag axle 90 may be lowered to distribute the loaded weight of the vehicle 100 across a greater number of a wheel and tire assemblies 54 (e.g., when the refuse vehicle 100 is loaded with refuse).

As shown in FIGS. 3 and 4, the application kit 80 of the refuse vehicle 100 includes a series of panels that form a rear body or container, shown as refuse compartment 130. The refuse compartment 130 may facilitate transporting refuse from various waste receptacles within a municipality to a storage and/or a processing facility (e.g., a landfill, an incineration facility, a recycling facility, etc.). By way of example, loose refuse may be placed into the refuse compartment 130 where it may be compacted (e.g., by a packer system within the refuse compartment 130). The refuse compartment 130 may also provide temporary storage for refuse during transport to a waste disposal site and/or a recycling facility. In some embodiments, the refuse compartment 130 may define a hopper volume 132 and storage volume 134. In this regard, refuse may be initially loaded into the hopper volume 132 and later compacted into the storage volume 134. As shown, the hopper volume 132 is positioned between the storage volume 134 and the cab 40 (e.g., refuse is loaded into a portion of the refuse compartment 130 behind the cab 40 and stored in a portion further toward the rear of the refuse compartment 130). In other embodiments, the storage volume may be positioned between the hopper volume and the cab 40 (e.g., in a rear-loading refuse truck, etc.). The application kit 80 of the refuse vehicle 100 further includes a pivotable rear portion, shown as tailgate 136, that is pivotally coupled to the refuse compartment 130. The tailgate 136 may be selectively repositionable between a closed position and an open position by an actuator (e.g., a hydraulic cylinder, an electric linear actuator, etc.), shown as tailgate actuator 138 (e.g., to facilitate emptying the storage volume).

As shown in FIGS. 3 and 4, the refuse vehicle 100 also includes an implement, shown as lift assembly 140, which is a front-loading lift assembly. According to an exemplary embodiment, the lift assembly 140 includes a pair of lift arms 142 and a pair of actuators (e.g., hydraulic cylinders, electric linear actuators, etc.), shown as lift arm actuators 144. The lift arms 142 may be rotatably coupled to the chassis 20 and/or the refuse compartment 130 on each side of the refuse vehicle 100 (e.g., through a pivot, a lug, a shaft, etc.), such that the lift assembly 140 may extend forward relative to the cab 40 (e.g., a front-loading refuse truck, etc.). In other embodiments, the lift assembly 140 may extend rearward relative to the application kit 80 (e.g., a rear-loading refuse truck). As shown in FIGS. 3 and 4, in an exemplary embodiment the lift arm actuators 144 may be positioned such that extension and retraction of the lift arm actuators 144 rotates the lift arms 142 about an axis extending through the pivot. In this regard, the lift arms 142 may be rotated by the lift arm actuators 144 to lift a refuse container over the cab 40. The lift assembly 140 further includes a pair of interface members, shown as lift forks 146, each pivotally coupled to a distal end of one of the lift arms 142. The lift forks 146 may be configured to engage a refuse container (e.g., a dumpster) to selectively couple the refuse container to the lift arms 142. By way of example, each of the lift forks 146 may be received within a corresponding pocket defined by the refuse container. A pair of actuators (e.g., hydraulic cylinders, electric linear actuators, etc.), shown as articulation actuators 148, are each coupled to one of the lift arms 142 and one of the lift forks 146. The articulation actuators 148 may be positioned to rotate the lift forks 146 relative to the lift arms 142 about a horizontal axis. Accordingly, the articulation actuators 148 may assist in tipping refuse out of the refuse container and into the refuse compartment 130. The lift arm actuators 144 may then rotate the lift arms 142 to return the empty refuse container to the ground.

### B. Side-loading Refuse Vehicle

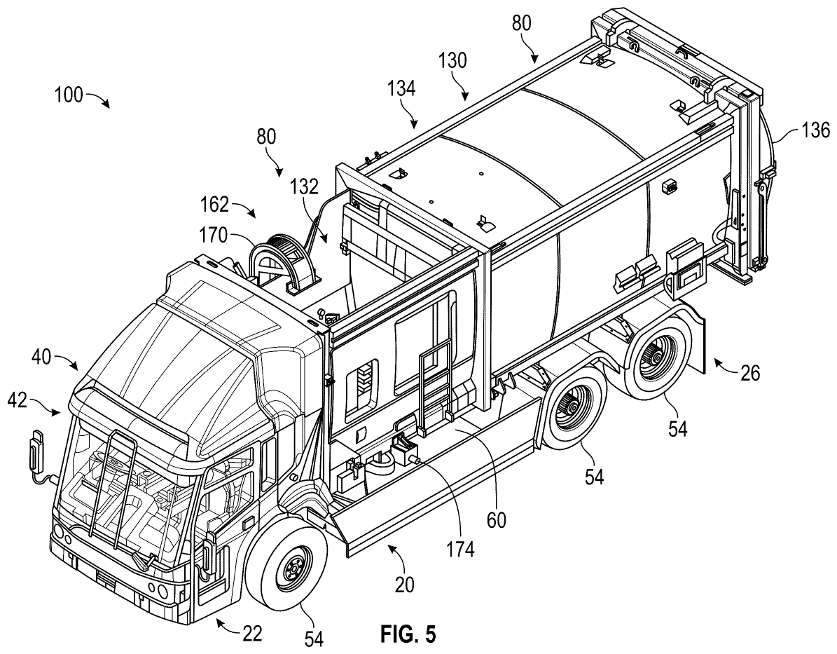

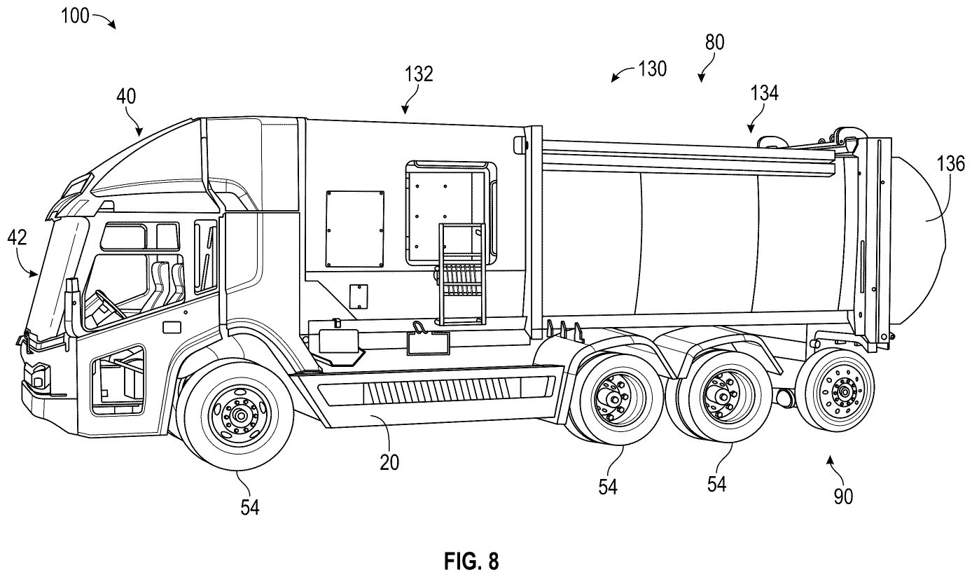

Referring now to FIGS. 5-8, an alternative configuration of the refuse vehicle 100 is shown according to an exemplary embodiment. Specifically, the refuse vehicle 100 of FIGS. 5-8 is configured as a side-loading refuse vehicle. The refuse vehicle 100 of FIGS. 5-8 may be substantially similar to the front-loading refuse vehicle 100 of FIGS. 3 and 4 except as otherwise specified herein. As shown in FIG. 8, the refuse vehicle 100 of FIGS. 5-7 may be configured with a tag axle 90.

Referring still to FIGS. 5-8, the refuse vehicle 100 omits the lift assembly 140 and instead includes a side-loading lift assembly, shown as lift assembly 160, that extends laterally outward from a side of the refuse vehicle 100. The lift assembly 160 includes an interface assembly, shown as grabber assembly 162, that is configured to engage a refuse container (e.g., a residential garbage can) to selectively couple the refuse container to the lift assembly 160. The grabber assembly 162 includes a main portion, shown as main body 164, and a pair of fingers or interface members, shown as grabber fingers 166. The grabber fingers 166 are pivotally coupled to the main body 164 such that the grabber fingers 166 are each rotatable about a vertical axis. A pair of actuators (e.g., hydraulic motors, electric motors, etc.), shown as finger actuators 168, are configured to control movement of the grabber fingers 166 relative to the main body 164.

The grabber assembly 162 is movably coupled to a guide, shown as track 170, that extends vertically along a side of the refuse vehicle 100. Specifically, the main body 164 is slidably coupled to the track 170 such that the main body 164 is repositionable along a length of the track 170. An actuator (e.g., a hydraulic motor, an electric motor, etc.), shown as lift actuator 172, is configured to control movement of the grabber assembly 162 along the length of the track 170. In some embodiments, a bottom end portion of the track 170 is straight and substantially vertical such that the grabber assembly 162 raises or lowers a refuse container when moving along the bottom end portion of the track 170. In some embodiments, a top end portion of the track 170 is curved such that the grabber assembly 162 inverts a refuse container to dump refuse into the hopper volume 132 when moving along the top end portion of the track 170.

The lift assembly 160 further includes an actuator (e.g., a hydraulic cylinder, an electric linear actuator, etc.), shown as track actuator 174, that is configured to control lateral movement of the grabber assembly 162. By way of example, the track actuator 174 may be coupled to the chassis 20 and the track 170 such that the track actuator 174 moves the track 170 and the grabber assembly 162 laterally relative to the chassis 20. The track actuator 174 may facilitate repositioning the grabber assembly 162 to pick up and replace refuse containers that are spaced laterally outward from the refuse vehicle 100.

### C. Concrete Mixer Truck

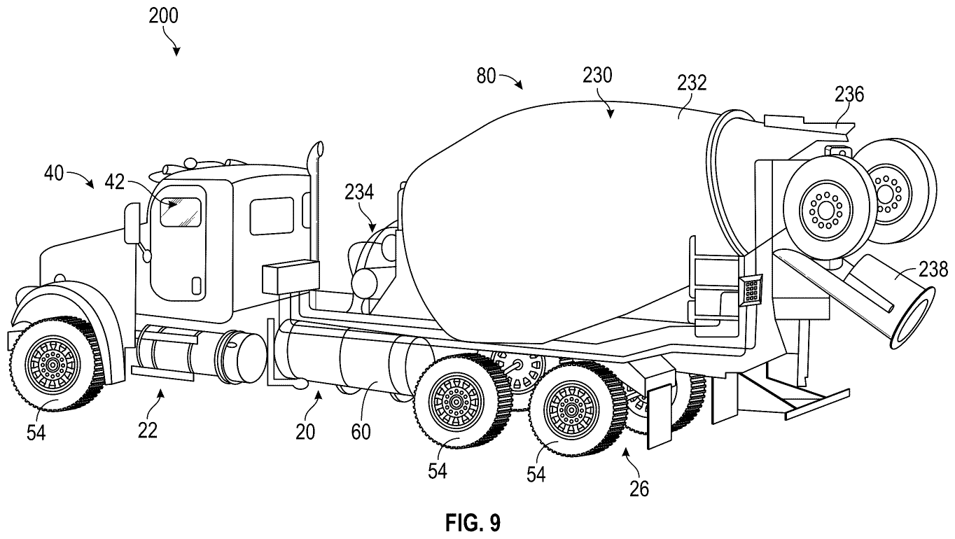

Referring now to FIG. 9, the vehicle 10 is configured as a mixer truck (e.g., a concrete mixer truck, a mixer vehicle, etc.), shown as mixer truck 200. Specifically, the mixer truck 200 is shown as a rear-discharge concrete mixer truck. In other embodiments, the mixer truck 200 is a front-discharge concrete mixer truck.

As shown in FIG. 9, the application kit 80 includes a mixing drum assembly (e.g., a concrete mixing drum), shown as drum assembly 230. The drum assembly 230 may include a mixing drum 232, a drum drive system 234 (e.g., a rotational actuator or motor, such as an electric motor or hydraulic motor), an inlet portion, shown as hopper 236, and an outlet portion, shown as chute 238. The mixing drum 232 may be coupled to the chassis 20 and may be disposed behind the cab 40 (e.g., at the rear and/or middle of the chassis 20). In an exemplary embodiment, the drum drive system 234 is coupled to the chassis 20 and configured to selectively rotate the mixing drum 232 about a central, longitudinal axis. According to an exemplary embodiment, the central, longitudinal axis of the mixing drum 232 may be elevated from the chassis 20 (e.g., from a horizontal plane extending along the chassis 20) at an angle in the range of five degrees to twenty degrees. In other embodiments, the central, longitudinal axis may be elevated by less than five degrees (e.g., four degrees, etc.). In yet another embodiment, the mixer truck 200 may include an actuator positioned to facilitate adjusting the central, longitudinal axis to a desired or target angle (e.g., manually in response to an operator input/command, automatically according to a control system, etc.).

The mixing drum 232 may be configured to receive a mixture, such as a concrete mixture (e.g., cementitious material, aggregate, sand, etc.), through the hopper 236. In some embodiments, the mixer truck 200 includes an injection system (e.g., a series of nozzles, hoses, and/or valves) including an injection valve that selectively fluidly couples a supply of fluid to the inner volume of the mixing drum 232. By way of example, the injection system may be used to inject water and/or chemicals (e.g., air entrainers, water reducers, set retarders, set accelerators, superplasticizers, corrosion inhibitors, coloring, calcium chloride, minerals, and/or other concrete additives, etc.) into the mixing drum 232. The injection valve may facilitate injecting water and/or chemicals from a fluid reservoir (e.g., a water tank, etc.) into the mixing drum 232, while preventing the mixture in the mixing drum 232 from exiting the mixing drum 232 through the injection system. In some embodiments, one or more mixing elements (e.g., fins, etc.) may be positioned in the interior of the mixing drum 232, and may be configured to agitate the contents of the mixture when the mixing drum 232 is rotated in a first direction (e.g., counterclockwise, clockwise, etc.), and drive the mixture out through the chute 238 when the mixing drum 232 is rotated in a second direction (e.g., clockwise, counterclockwise, etc.). In some embodiments, the chute 238 may also include an actuator positioned such that the chute 238 may be selectively pivotable to position the chute 238 (e.g., vertically, laterally, etc.), for example at an angle at which the mixture is expelled from the mixing drum 232.

### D. Fire Truck

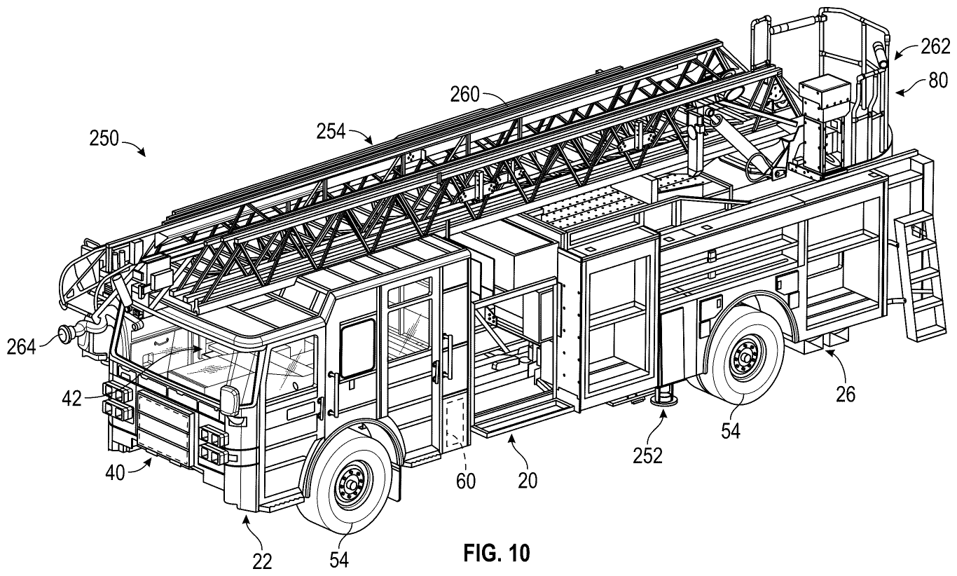

Referring now to FIG. 10, the vehicle 10 is configured as a fire fighting vehicle, fire truck, or fire apparatus (e.g., a turntable ladder truck, a pumper truck, a quint, etc.), shown as fire fighting vehicle 250. In the embodiment shown in FIG. 10, the fire fighting vehicle 250 is configured as a rear-mount aerial ladder truck. In other embodiments, the fire fighting vehicle 250 is configured as a mid-mount aerial ladder truck, a quint fire truck (e.g., including an on-board water storage, a hose storage, a water pump, etc.), a tiller fire truck, a pumper truck (e.g., without an aerial ladder), or another type of response vehicle. By way of example, the vehicle 10 may be configured as a police vehicle, an ambulance, a tow truck, or still other vehicles used for responding to a scene (e.g., an accident, a fire, an incident, etc.).

As shown in FIG. 10, in the fire fighting vehicle 250, the application kit 80 is positioned mainly rearward from the cab 40. The application kit 80 includes deployable stabilizers (e.g., outriggers, downriggers, etc.), shown as outriggers 252, that are coupled to the chassis 20. The outriggers 252 may be configured to selectively extend from each lateral side and/or the rear of the fire fighting vehicle 250 and engage a support surface (e.g., the ground) in order to provide increased stability while the fire fighting vehicle 250 is stationary. The fire fighting vehicle 250 further includes an extendable or telescoping ladder assembly, shown as ladder assembly 254. The increased stability provided by the outriggers 252 is desirable when the ladder assembly 254 is in use (e.g., extended from the fire fighting vehicle 250) to prevent tipping. In some embodiments, the application kit 80 further includes various storage compartments (e.g., cabinets, lockers, etc.) that may be selectively opened and/or accessed for storage and/or component inspection, maintenance, and/or replacement.

As shown in FIG. 10, the ladder assembly 254 includes a series of ladder sections 260 that are slidably coupled with one another such that the ladder sections 260 may extend and/or retract (e.g., telescope) relative to one another to selectively vary a length of the ladder assembly 254. A base platform, shown as turntable 262, is rotatably coupled to the chassis 20 and to a proximal end of a base ladder section 260 (i.e., the most proximal of the ladder sections 260). The turntable 262 may be configured to rotate about a vertical axis relative to the chassis 20 to rotate the ladder sections 260 about the vertical axis (e.g., up to 360 degrees, etc.). The ladder sections 260 may rotate relative to the turntable 262 about a substantially horizontal axis to selectively raise and lower the ladder sections 260 relative to the chassis 20. As shown, a water turret or implement, shown as monitor 264, is coupled to a distal end of a fly ladder section 260 (i.e., the most distal of the ladder sections 260). The monitor 264 may be configured to expel water and/or a fire suppressing agent (e.g., foam, etc.) from a water storage tank and/or an agent tank onboard the fire fighting vehicle 250, and/or from an external source (e.g., a fire hydrant, a separate water/pumper truck, etc.). In some embodiments, the ladder assembly 254 further includes an aerial platform coupled to the distal end of the fly ladder section 260 and configured to support one or more operators.

### E. ARFF Truck

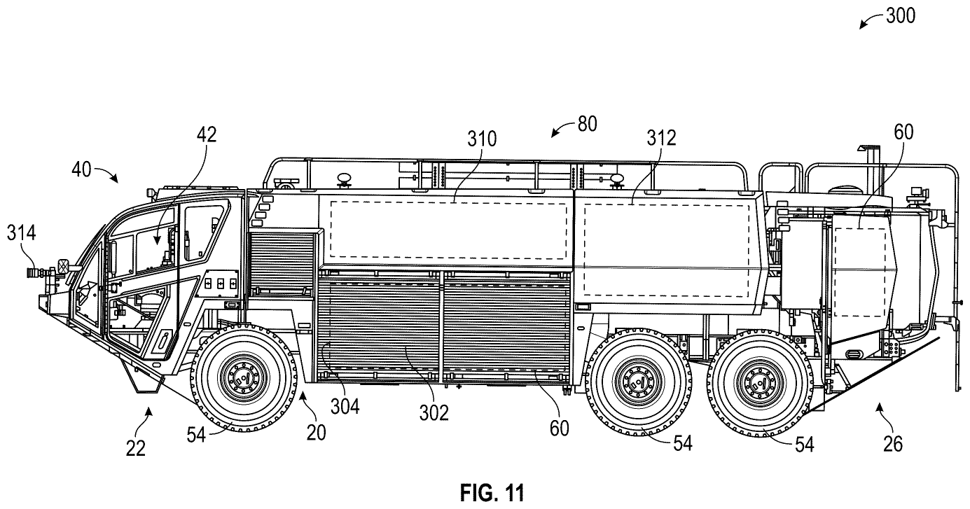

Referring now to FIG. 11, the vehicle 10 is configured as a fire fighting vehicle, shown as airport rescue and fire fighting (ARFF) truck 300. As shown in FIG. 11, the application kit 80 is positioned primarily rearward of the cab 40. As shown, the application kit 80 includes a series of storage compartments or cabinets, shown as compartments 302, that are coupled to the chassis 20. The compartments 302 may store various equipment or components of the ARFF truck 300.

The application kit 80 includes a pump system 304 (e.g., an ultra-high-pressure pump system, etc.) positioned within one of the compartments 302 near the center of the ARFF truck 300. The application kit 80 further includes a water tank 310, an agent tank 312, and an implement or water turret, shown as monitor 314. The pump system 304 may include a high pressure pump and/or a low pressure pump, which may be fluidly coupled to the water tank 310 and/or the agent tank 312. The pump system 304 may to pump water and/or fire suppressing agent from the water tank 310 and the agent tank 312, respectively, to the monitor 314. The monitor 314 may be selectively reoriented by an operator to adjust a direction of a stream of water and/or agent. As shown in FIG. 11, the monitor 314 is coupled to a front end of the cab 40.

### F. Boom Lift

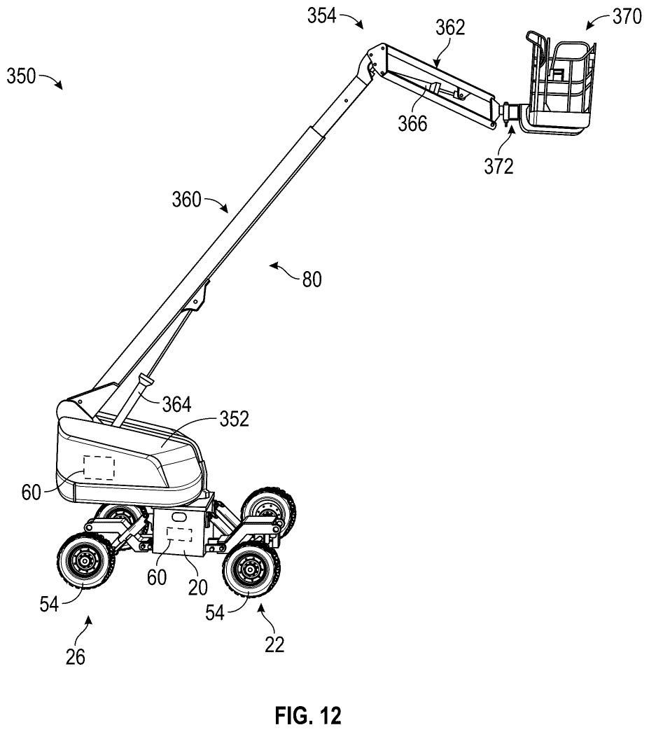

Referring now to FIG. 12, the vehicle 10 is configured as a lift device, shown as boom lift 350. The boom lift 350 may be configured to support and elevate one or more operators. In other embodiments, the vehicle 10 is configured as another type of lift device that is configured to lift operators and/or material, such as a skid-loader, a telehandler, a scissor lift, a fork lift, a vertical lift, and/or any other type of lift device or machine.

As shown in FIG. 12, the application kit 80 includes a base assembly, shown as turntable 352, that is rotatably coupled to the chassis 20. The turntable 352 may be configured to selectively rotate relative to the chassis 20 about a substantially vertical axis. In some embodiments, the turntable 352 includes a counterweight (e.g., the batteries) positioned near the rear of the turntable 352. The turntable 352 is rotatably coupled to a lift assembly, shown as boom assembly 354. The boom assembly 354 includes a first section or telescoping boom section, shown as lower boom 360. The lower boom 360 includes a series of nested boom sections that extend and retract (e.g., telescope) relative to one another to vary a length of the boom assembly 354. The boom assembly 354 further includes a second boom section or four bar linkage, shown as upper boom 362. The upper boom 362 may includes structural members that rotate relative to one another to raise and lower a distal end of the boom assembly 354. In other embodiments, the boom assembly 354 includes more or fewer boom sections (e.g., one, three, five, etc.) and/or a different arrangement of boom sections.

As shown in FIG. 12, the boom assembly 354 includes a first actuator, shown as lower lift cylinder 364. The lower boom 360 is pivotally coupled (e.g., pinned, etc.) to the turntable 352 at a joint or lower boom pivot point. The lower lift cylinder 364 (e.g., a pneumatic cylinder, an electric linear actuator, a hydraulic cylinder, etc.) is coupled to the turntable 352 at a first end and coupled to the lower boom 360 at a second end. The lower lift cylinder 364 may be configured to raise and lower the lower boom 360 relative to the turntable 352 about the lower boom pivot point.

The boom assembly 354 further includes a second actuator, shown as upper lift cylinder 366. The upper boom 362 is pivotally coupled (e.g., pinned) to the upper end of the lower boom 360 at a joint or upper boom pivot point. The upper lift cylinder 366 (e.g., a pneumatic cylinder, an electric linear actuator, a hydraulic cylinder, etc.) is coupled to the upper boom 362. The upper lift cylinder 366 may be configured to extend and retract to actuate (e.g., lift, rotate, elevate, etc.) the upper boom 362, thereby raising and lowering a distal end of the upper boom 362.

Referring still to FIG. 12, the application kit 80 further includes an operator platform, shown as platform assembly 370, coupled to the distal end of the upper boom 362 by an extension arm, shown as jib arm 372. The jib arm 372 may be configured to pivot the platform assembly 370 about a lateral axis (e.g., to move the platform assembly 370 up and down, etc.) and/or about a vertical axis (e.g., to move the platform assembly 370 left and right, etc.).

The platform assembly 370 provides a platform configured to support one or more operators or users. In some embodiments, the platform assembly 370 may include accessories or tools configured for use by the operators. For example, the platform assembly 370 may include pneumatic tools (e.g., an impact wrench, airbrush, nail gun, ratchet, etc.), plasma cutters, welders, spotlights, etc. In some embodiments, the platform assembly 370 includes a control panel (e.g., a user interface, a removable or detachable control panel, etc.) configured to control operation of the boom lift 350 (e.g., the turntable 352, the boom assembly 354, etc.) from the platform assembly 370 or remotely. In other embodiments, the platform assembly 370 is omitted, and the boom lift 350 includes an accessory and/or tool (e.g., forklift forks, etc.) coupled to the distal end of the boom assembly 354.

### G. Scissor Lift

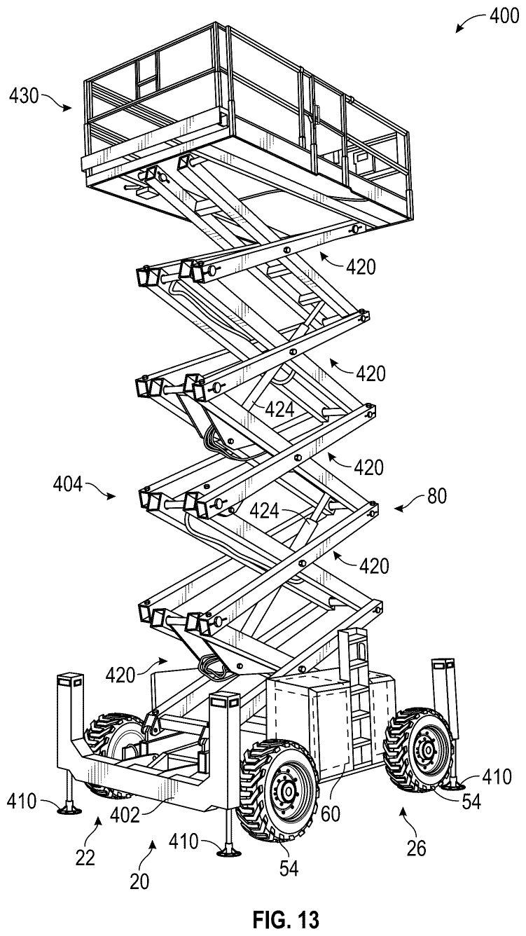

Referring now to FIG. 13, the vehicle 10 is configured as a lift device, shown as scissor lift 400. As shown in FIG. 13, the application kit 80 includes a body, shown as lift base 402, coupled to the chassis 20. The lift base 402 is coupled to a scissor assembly, shown as lift assembly 404, such that the lift base 402 supports the lift assembly 404. The lift assembly 404 is configured to extend and retract, raising and lowering between a raised position and a lowered position relative to the lift base 402.

As shown in FIG. 13, the lift base 402 includes a series of actuators, stabilizers, downriggers, or outriggers, shown as leveling actuators 410. The leveling actuators 410 may extend and retract vertically between a stored position and a deployed position. In the stored position, the leveling actuators 410 may be raised, such that the leveling actuators 410 do not contact the ground. Conversely, in the deployed position, the leveling actuators 410 may engage the ground to lift the lift base 402. The length of each of the leveling actuators 410 in their respective deployed positions may be varied in order to adjust the pitch (e.g., rotational position about a lateral axis) and the roll (e.g., rotational position about a longitudinal axis) of the lift base 402 and/or the chassis 20. Accordingly, the lengths of the leveling actuators 410 in their respective deployed positions may be adjusted to level the lift base 402 with respect to the direction of gravity (e.g., on uneven, sloped, pitted, etc. terrain). The leveling actuators 410 may lift the wheel and tire assemblies 54 off of the ground to prevent movement of the scissor lift 400 during operation. In other embodiments, the leveling actuators 410 are omitted.

The lift assembly 404 may include a series of subassemblies, shown as scissor layers 420, each including a pair of inner members and a pair of outer members pivotally coupled to one another. The scissor layers 420 may be stacked atop one another in order to form the lift assembly 404, such that movement of one scissor layer 420 causes a similar movement in all of the other scissor layers 420. The scissor layers 420 extend between and couple the lift base 402 and an operator platform (e.g., the platform assembly 430). In some embodiments, scissor layers 420 may be added to, or removed from, the lift assembly 404 in order to increase, or decrease, the fully extended height of the lift assembly 404.

Referring still to FIG. 13, the lift assembly 404 may also include one or more lift actuators 424 (e.g., hydraulic cylinders, pneumatic cylinders, electric linear actuators such as motor-driven leadscrews, etc.) configured to extend and retract the lift assembly 404. The lift actuators 424 may be pivotally coupled to inner members of various scissor layers 420, or otherwise arranged within the lift assembly 404.

A distal or upper end of the lift assembly 404 is coupled to an operator platform, shown as platform assembly 430. The platform assembly 430 may perform similar functions to the platform assembly 370, such as supporting one or more operators, accessories, and/or tools. The platform assembly 430 may include a control panel to control operation of the scissor lift 400. The lift actuators 424 may be configured to actuate the lift assembly 404 to selectively reposition the platform assembly 430 between a lowered position (e.g., where the platform assembly 430 is proximate to the lift base 402) and a raised position (e.g., where the platform assembly 430 is at an elevated height relative to the lift base 402). Specifically, in some embodiments, extension of the lift actuators 424 moves the platform assembly 430 upward (e.g., extending the lift assembly 404), and retraction of the lift actuators 424 moves the platform assembly 430 downward (e.g., retracting the lift assembly 404). In other embodiments, extension of the lift actuators 424 retracts the lift assembly 404, and retraction of the lift actuators 424 extends the lift assembly 404.

### Charging Port

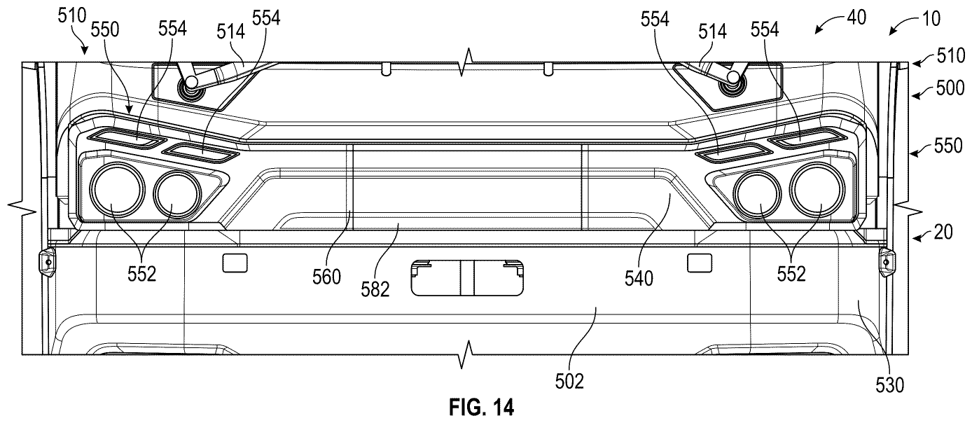

Referring now to FIGS. 14-16, a front end portion of the vehicle 10 is shown as front end 500 according to an exemplary embodiment. The front end 500 is a portion of the cab 40. The front end 500 defines a front surface 502 of the vehicle 10. The front surface 502 may extend substantially perpendicular to a direction of travel of the vehicle 10. The front end 500 of the vehicle 10 includes a pair of front portions, shown as a-pillars 510. The front end 500 further includes a windscreen or front window, shown as windshield 512, that extends between the a-pillars 510. The windshield 512 may be transparent to permit a forward-facing line of sight of an operator of the vehicle 10.

The front end 500 further includes a pair of wiper assemblies, shown as windshield wipers 514, that are movable across the windshield 512 to remove water or other debris. Specifically, each windshield wiper 514 is repositionable between an inner position 514A and an outer position 514B. The windshield wipers 514 each pivot about an axis extending below the windshield 512.

The front end 500 includes a protrusion, shown as bumper 530. The bumper 530 extends laterally across the front surface 502. The bumper 530 may extend forwardmost of any component of the front end 500. Accordingly, the bumper 530 may be the first component to contact in the event of a forward collision with another vehicle or object. The front end 500 further includes a front cover or body panel, shown as grille 540. The grille 540 extends between the bumper 530 and the windshield 512.

The grille 540 is coupled to a pair of light assemblies, shown as light clusters 550. Each light cluster 550 includes one or more lights, headlights, or electrical components. Each light cluster 550 includes a pair of headlights 552 (e.g., low-beam lights, high-beam lights, fog lights, etc.) and a pair of indicator lights 554 (e.g., turn signals, running lights, etc.). As shown in FIG. 14, the light clusters 550 are laterally spaced from one another with the grille 540 extending between the light clusters 550. The grille 540 defines a series of apertures, through which light generated by the headlights 552 and indicator lights 554 can exit the vehicle 10.

The front end 500 further includes a selectively-accessible port assembly, shown as port enclosure 560. The port enclosure 560 is positioned along the front surface 502 of the vehicle 10 between the light clusters 550, approximately laterally centered on the front end 500. The port enclosure 560 is at least partially defined by the grille 540. In other embodiments, the port enclosure 560 may be positioned offset from the lateral midpoint of the grille 540. In yet other embodiments, the port enclosure 560 is positioned along another portion of the vehicle 10. By way of example, the port enclosure 560 may be positioned along a left side, a right side, a rear side, a top side, or a bottom side of the vehicle 10.

The port enclosure 560 contains one or more connectors (e.g., electrical connectors, hydraulic connectors, pneumatic connectors, mechanical energy inputs, etc.) or ports, shown as charging port 570. The charging port 570 is electrically coupled to one or more components of the system by one or more cables 572. In some embodiments, the charging port 570 is electrically coupled to the batteries 60 (e.g., through one or more inverters or other power converters). The charging port 570 may supply electrical energy to charge the batteries 60. In other embodiments, the charging port 570 additionally or alternatively contains another type of port or connector (e.g., a hydraulic port, a pneumatic port, an input shaft, etc.). In other embodiments, the port enclosure 560 is configured to receive additional or alternative components of the vehicle 10 such as straps, tools, or the like.

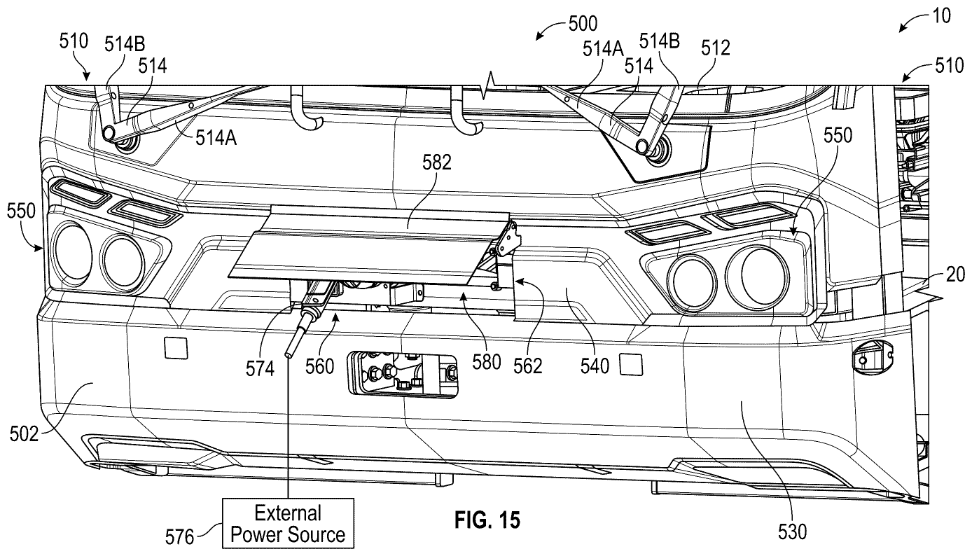

As shown in FIGS. 15-17, the charging port 570 is configured to selectively engage a connector, shown as a charging connector 574. Specifically, the charging port 570 is a female connector configured to receive an end of the charging connector 574. In other embodiments, the charging port 570 is a male connector that is received by the charging connector 574. The charging connector 574 may be selectively disengaged from the charging port 570 to remove the charging connector 574. The charging connector 574 is coupled to an external power source 576 (e.g., shore power, a generator, a solar panel, a power grid, etc.). The external power source 576 is configured to supply electrical energy to the vehicle 10 through the charging connector 574 and the charging port 570.

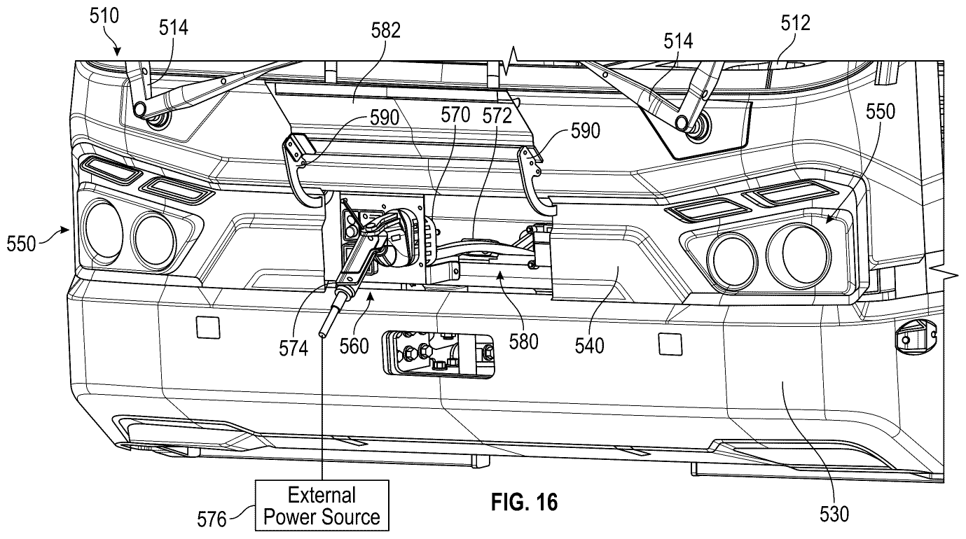

The port enclosure 560 defines a recess, shown as recess 580, that receives the charging port 570. The recess 580 extends inward from the front surface 502. The recess 580 is substantially laterally centered between the light clusters 550. As shown in FIG. 16, the recess 580 is wider than the charging port 570. This additional width may facilitate access to the cables 572 (e.g., for maintenance). Additionally or alternatively, the width of the recess 580 may facilitate additional ports within the recess 580.

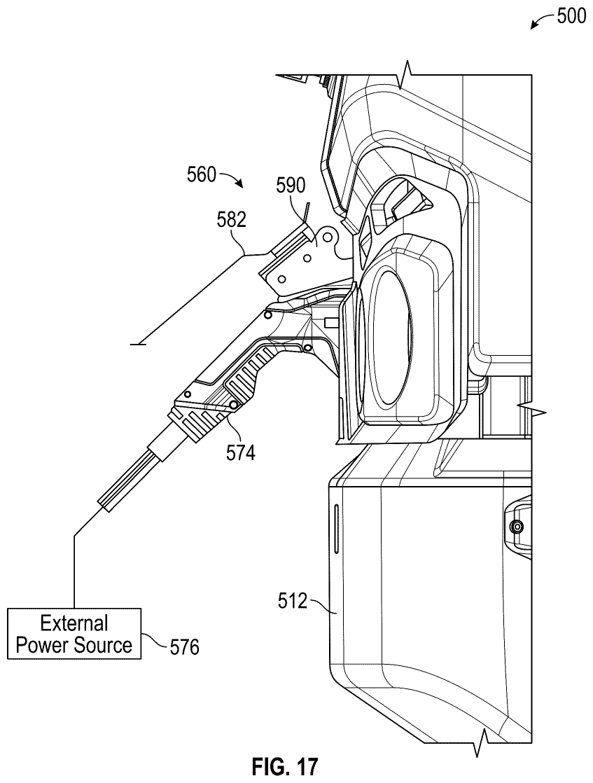

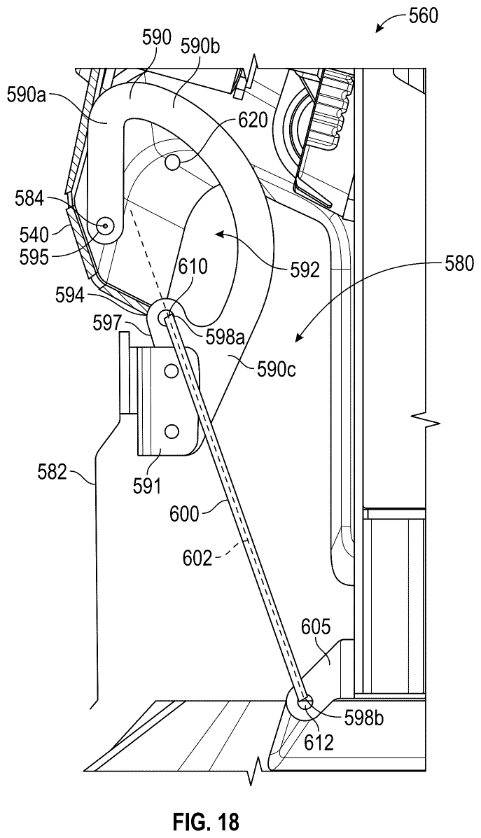

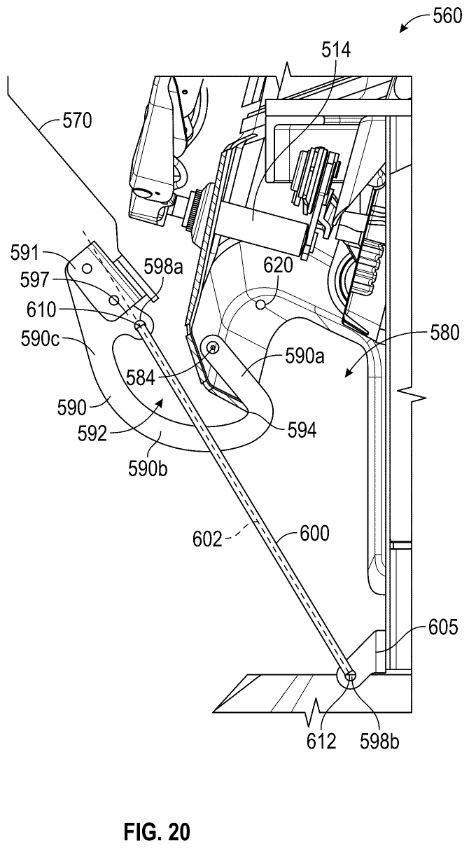

Referring to FIGS. 14-20, the port enclosure 560 further includes a cover, port door, door, or panel, shown as port door 582, that selectively covers the recess 580. The port door 582 is pivotally coupled to the grille 540, such that the port door 582 rotates about a horizontal, laterally-extending axis of rotation, shown as axis 584. As shown in FIG. 18, the axis 584 is positioned inward of a top portion of the grille 540, above the recess 580. In other embodiments, the axis 584 is otherwise positioned. The port door 582 is selectively repositionable between a closed position (e.g., shown in FIGS. 14 and 18) and an open position (e.g., shown in FIGS. 16 and 20). In some embodiments, the port door 582 is further repositionable into a charging position or middle position (e.g., shown in FIGS. 15 and 17) between the closed position and the open position.

In some embodiments, the port door 582 is repositionable by a user. By way of example, the user may apply an outward and/or upward force onto the port door 582 to reposition the port door from the closed position toward the open position. By way of another example, the user may apply an inward and/or downward force onto the port door 582 to reposition the port door from the open position toward the closed position.

As shown in FIGS. 15 and 18, in the closed position, the port door 582 extends across the recess 580, separating the volume of the recess 580 from the surrounding environment. In the closed position, the port door 582 may prevent ingress of debris (e.g., dirt, rocks, insects, water, etc.) into the charging port 570. The benefits of the port door 582 may be even further pronounced, due to the increased incidence of debris on the front of the vehicle 10 when travelling forward. In some embodiments, the port door 582 extends parallel to (e.g., coplanar with) the grille 540 when in the closed position. The recess 580 may be dimensionally similar to or smaller than the port door 582, such that the port door 582 is received within the recess 580. In other embodiments, the port door 582 is partially received within the recess 580 when the port door 582 is in the closed position. In still other embodiments, the port door 582 is not received within the recess 580 when the port door 582 is in the closed position.

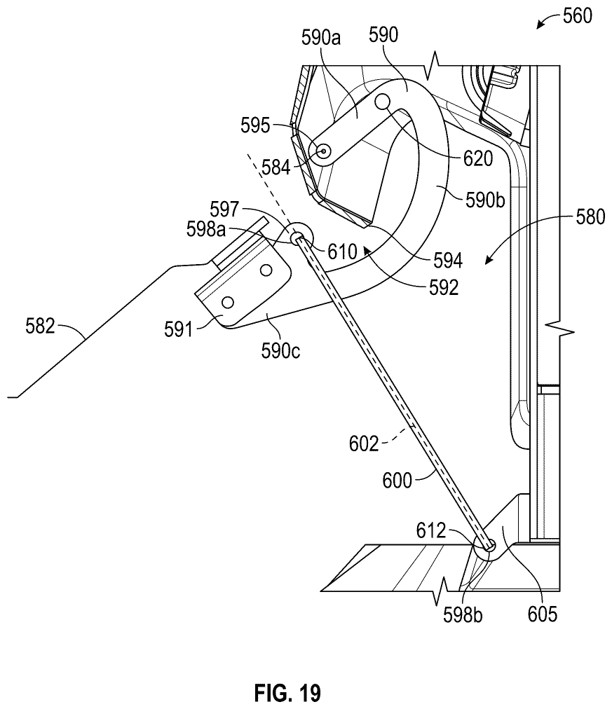

As shown in FIGS. 16 and 19, in the open position, the port door 582 is moved away from the recess 580, ensuring that the charging port 570 is unobstructed by the port door 582. Specifically, the port door 582 is moved upward, above the recess 580. The open position may facilitate movement of the charging connector 574 into or out of the recess 580. Accordingly, the open position may facilitate connecting or disconnecting the charging connector 574 from the charging port 570.

As shown in FIGS. 17 and 20, in the charging position, the port door 582 extends partially across the recess 580 in a generally forward and downward direction. In the charging position, the port door 582 may protect the charging port 570 and the charging connector 574 from debris. Particularly, the port door 582 may protect the charging port 570 and the charging connector 574 from downward-falling debris.

Referring to FIGS. 18-20, the port enclosure 560 includes one or more hinges, arms, or members, shown as hinge members 590. The hinge members 590 are pivotally coupled to the grille 540 and fixedly coupled to the port door 582. The port door 582 is coupled to the grille 540 by the hinge members 590. The hinge members 590 each include a first portion 590a that is directly, pivotally coupled to the grille 540. The first portion 590a is substantially linear. A first end of the first portion 590a defines a first pivot point 595 for the hinge members 590. The first pivot point 595 may be an aperture that receives a protrusion of the grille 540. Rotation of the hinge member 590 occurs about the first pivot point 595, such that the axis 584 extends through the pivot point 595.

The hinge members 590 each include a second portion 590b fixedly coupled to the first portion 590a. The second portion 590b is curved. The second portion 590b extends downward and inward into the recess 580 when the port door 582 is in the closed position. Each hinge member 590 includes a third portion 590c fixedly coupled to the second portion 590b and the port door 582. The port enclosure 560 may include one or more fasteners (e.g., apertures, nuts, bolts, screws, etc.) that couple to the port door 582 to the third portion 590c. As shown, a bracket, shown as angle bracket 591, couples the port door 582 to the third portion 590c. In some embodiments, the first portion 590a, the second portion 590b, and the third portion 590c are integrally formed as a single, continuous piece. In other embodiments, the first portion 590a, the second portion 590b, and/or the third portion 590c are otherwise shaped.

The shapes of the first portion 590a, the second portion 590b, and the third portion 590c form a concave structure that defines a recess, cavity, or indentation, shown as swing recess 592. The swing recess 592 faces toward an edge 594 of the grille 540 that forms the recess 580. The swing recess 592 provides clearance between the hinge member 590 and the grille 540 as the port door 582 swings toward the open position. The edge 594 may be received within the swing recess 592 at least when the port door 582 the open position (e.g., when the port door 582 is the charging position, when the port door 582 is between the charging position and the open position, etc.).

Each hinge member 590 further includes an elongated member 597 extending from the third portion 590c. The elongated member 597 extends towards the first pivot point 595 and into the swing recess 592. In other embodiments, the elongated member 597 extends substantially away from the first pivot point 595. The elongated member 597 defines an aperture 598a located at an end of the elongated member 597.

The port enclosure 560 further includes a pair of biasing elements (e.g., gas springs, dampers, compression springs, cylinders, etc.), shown as gas springs 600. Each gas spring 600 is a compressive member configured to apply a biasing force along an axis 602. The biasing force is directed to extending the length of the gas spring 600 along the axis 602.

The port enclosure 560 further includes a pair of brackets 605 fixedly coupled to the cab 40. Each bracket defines an aperture 598b extending laterally through the bracket 605. The brackets 605 are positioned within the recess 580. Specifically, the brackets 605 are positioned within a lower portion of the recess 580, opposite the hinge members 590.

Each gas spring 600 is coupled to one of the hinge members 590 and one of the brackets 605. Specifically, a first end of the gas spring 600 is pivotally coupled to the hinge member 590. By way of example, the aperture 598a may receive a protrusion coupled to the first end of the gas spring 600. The first end of the gas spring 600 may rotate relative to the hinge member 590 about an axis of rotation 610 that extends through the center of the aperture 598a. A second end of the gas spring 600 is pivotally coupled to the bracket 605. By way of example, the aperture 598b may receive a protrusion coupled to the second end of the gas spring 600. The second end of the gas spring 600 may rotate relative to the bracket 605 about an axis of rotation 612 that extends through the center of the aperture 598b.

The gas springs 600 apply a biasing force on the hinge members 690 and the port door 582. The magnitude and direction of the biasing force may vary based on the position of the port door 582. The biasing force acts along the axis 602. Accordingly, when the axis 602 extends inward of the axis 584 (e.g., as shown in FIG. 18), the biasing force imparts a positive moment effect on the port door 582. Accordingly, the gas springs 600 bias the port door 582 toward the closed position. When the axis 602 extends outward of the axis 584 (e.g., as shown in FIGS. 19 and 20), the biasing force imparts a negative moment effect on the port door 582. Accordingly, the gas springs 600 bias the port door 582 toward the open position.

Due to the relative positions of the pivot point 595, the aperture 598a, and the aperture 598b, the gas springs 600 are configured to inwardly bias the hinge member 590 when the port door 582 is in the closed position (e.g., the gas spring applies a force tending to hold the port door 582) and to outwardly bias the hinge member 590 (e.g., applying a force tending to cause the port door 582 to swing open) when the port door 582 is in the charging position or the open position. The moment effect of the biasing forces of the gas springs 600 may be negligible (e.g., substantially no torque) when the port door 582 is in an intermediate transition position in which the axis 602 is aligned with the axis 584. In some embodiments, the transition position is between the closed position and the charge position, such that the gas springs 600 switch between biasing the port door 582 inward and outward as the port door 582 moves between the closed position and the charge position.

In some embodiments, the port enclosure 560 includes one or more stops, protrusions, detents, magnets, latches, bumpers, etc., shown as stop 620. The stop 620 may facilitate holding the port door 582 in the charge position, opposing the biasing force of the gas springs 600. The stop 620 may be configured to engage at least one of the hinge member 590 or the gas spring 600. Specifically, the stop 620 may abut at least one of the hinge member 590 or the gas spring 600 when the port door 582 is positioned in the charging position. In other embodiments, the stop 620 may abut at least one of the hinge member 590 or the gas spring 600 when the port door 582 is transitioning between the closed position and the charging position, or transitioning between the charging position and the open position. The stop 620 may apply a holding force onto the hinge member 590 or gas spring 600 to maintain the port door 582 in the charging position. The holding force may be overcome by applying a threshold torque (e.g., in an inward direction, in an outward direction, etc.) on the port door 582. The threshold torque may be less than the moment effect of the gas springs 600 on the port door 582 when the port door 582 is in the charging position.

In some embodiments, the stop 620 includes a detent. The detent may be positioned on an inner portion of the grille 540 and extend from the grille 540 toward the hinge member 590. In such an embodiment, the detent abuts the hinge member 590 when the port door 582 is repositioned into the charging position. In this configuration, the biasing force from the gas springs 600 is insufficient to overcome the holding force of the detent, and the detent maintains the port door 582 in the charging position. The stop 620 may include a single detent or a plurality of detents.

In some embodiments, the stop 620 includes a magnet. The magnet may be positioned on an inner portion of the upper bumper and magnetically engage a hinge member 590 when the port door 582 is repositioned into the charging position. The magnetic force provided onto the hinge member 590 may be strong enough to overcome the outward bias provided by the gas springs 600 onto the port door 582 such that the port door 582 is maintained in the charging position.

In other embodiments, the stop 620 is omitted. In some such embodiments, the gas springs 600 may reach their full extension when the port door 582 is in the charging position. With the gas springs 600 at full extension, the gas springs 600 no longer provide an outward biasing force beyond the charging position. Accordingly, the gas springs 600 may hold the port door 582 in the charging position without forcing the port door 582 onward to the open position. To move the port door 582 to the open position, the user may manually lift the port door 582. To facilitate movement of the port door 582, the port door 582 may be selectively coupled to the gas springs 600. By way of example, the port enclosure 560 may include a disconnect feature (e.g., quick disconnect, etc.) that selectively decouples the port door 582 from the gas springs 600 to permit movement of the port door 582 beyond the charging position. For example, if the gas springs 600 are fully extended when the port door 582 is in the charging position, the gas springs 600 may be disconnected from the hinge member 590 or the bracket 605 so that the port door 582 can be opened further (e.g., to the open position, shown in FIG. 20). By way of another example, the gas springs 600 may be coupled to a first one of the hinge members 590, and the port door 582 may be fixedly coupled to a second one of the hinge members 590. The port door 582 may rest against the first one of the hinge members 590. To reach the open position, the port door 582 and the second one of the hinge members 590 may be lifted off of the first one of the hinge members 590. An outer portion of the grille 540 may include a latch (e.g., magnet, latch, etc.) configured to hold the port door 582 in the open position.

In other embodiments where the stop 620 is omitted, the port door 582 is not held in the charging position (e.g., the port door 582 is held only in the closed position and the open position). The gas springs 600 may hold the port door 582 in the open position or the closed position.

Referring now to FIGS. 18-20, an exemplary operating cycle of the port door 582 is described. As shown in FIG. 18, when the port door 582 is in the closed position, a first positive (e.g., clockwise) moment is imparted onto the hinge members 590 by the gas springs 600. This first biasing moment holds the port door 582 in the closed position (e.g., holds the port door 582 against a hard stop). The first biasing moment prevents the port door 582 from unintentionally opening. In some embodiments, the port enclosure 560 further includes a latch to secure the port door 582 into the closed position. The latch may include a release positioned on an outer portion of the port enclosure 560. A user may interact with the release to release the latch.

When a user desires to interact with the charging port 570, the user may apply an outward force on the port door 582 to overcome the biasing moment and move the port door 582 outward. When the port door 582 reaches the transition position, the biasing moment is approximately negligible, and the gas spring 600 is maximally compressed. Moving the port door 582 beyond this point in the outward direction cause the gas springs 600 to outwardly bias the hinge member 590, providing a negative (e.g., clockwise) biasing moment. The port door 582 may be moved outwardly to the charging position.

Referring now to FIG. 19, when the port door 582 is in the charging position, the biasing moment biases the port door 582 toward the open position. The stop 620 may hold the port door 582 in the charging position until the user applies a force to the stop. If the force applied by the user is sufficient to overcome the holding force, the port door 582 moves out of the charging position. If the user applies an outward force, the port door 582 moves to the open position.

Referring now to FIG. 20, when the port door 582 is in the open position, the biasing moment holds the port door 582 in the open position. The user may engage the charging connector 574 with the charging port 570. The user may then apply a downward force on the port door 582 to move the port door 582 to the charging position. The stop 620 may hold the port door 582 in the charging position. To remove the charging connector 574 (e.g., because charging is complete and/or the user would like to drive the vehicle 10), the process may be followed in reverse.

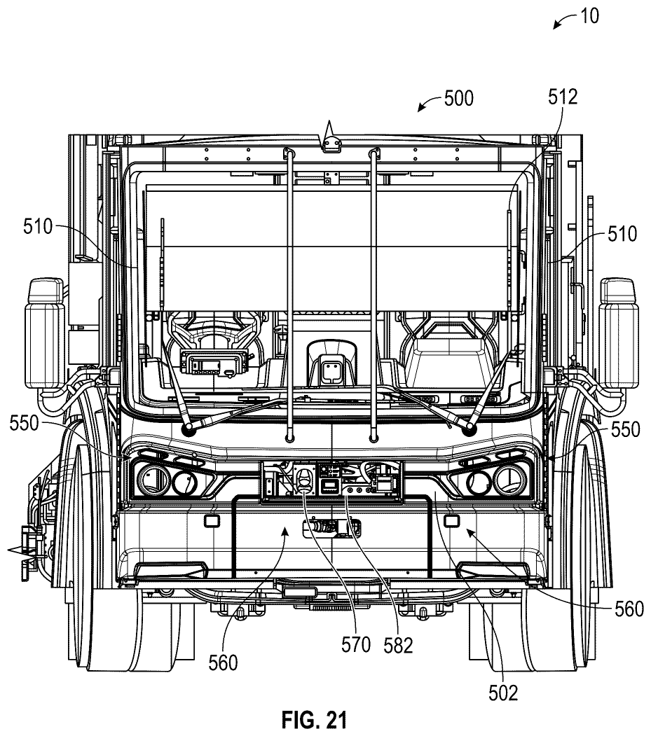

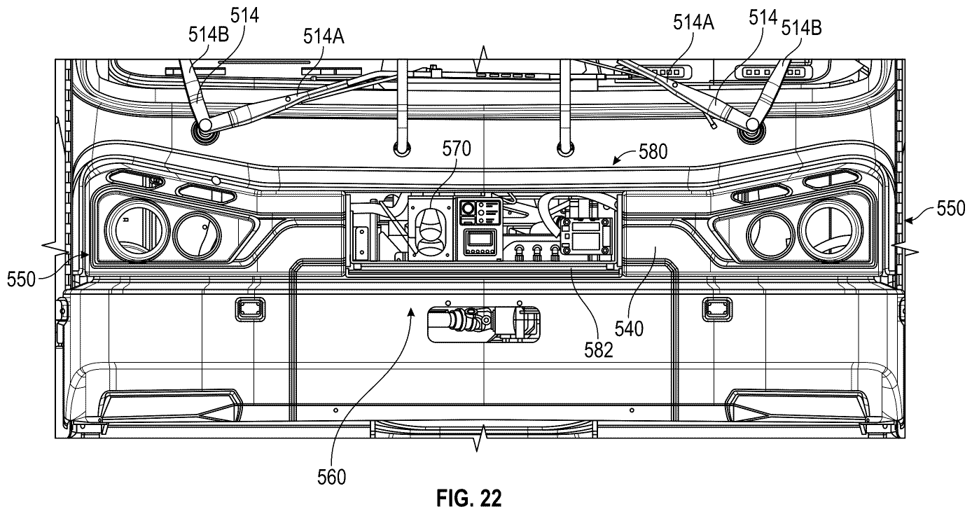

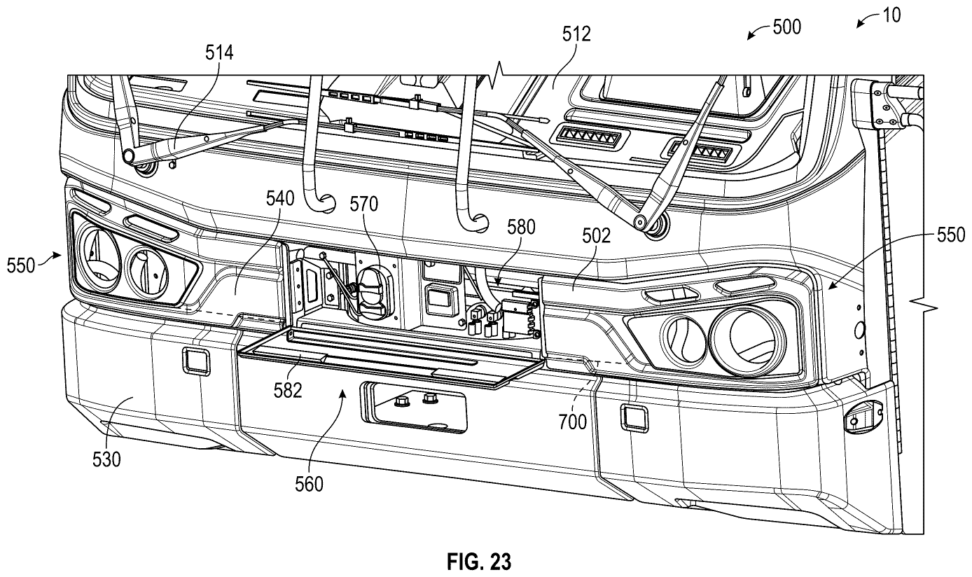

FIGS. 14-20 illustrate an embodiment in which the port door 582 rotates upward to the open position. In an alternative embodiment shown in FIGS. 21-23, the port door 582 rotates downward to the open position. In such an embodiment, the port door 582 may not have a defined charging position between the closed position and the open position. When the port door 582 is in the open position, the port door 582 is positioned below the recess 580. The port door 582 may be directly pivotally coupled to the grille 540. The port door 582 may be rotatable a horizontal, laterally-extending axis of rotation, shown as axis 700, that extends along the bottom of the recess 580.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data that cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A vehicle comprising:
a chassis;
a body coupled to the chassis and having a front surface, the body defining a recess positioned along the front surface and extending rearward from the front surface;
a port coupled to the body and positioned within the recess;
a door movably coupled to the body and selectively repositionable between a closed position and an open position;
a panel coupled to the body, extending along the front surface, and having an edge that at least partially defines the recess; and
a hinge member pivotally coupling the door to the body, wherein the hinge member defines a swing recess that receives the edge when the door is in the open position,
wherein, in the closed position, the door extends across the recess and obstructs access to the port,
wherein, in the open position, the door permits access to the port, and
wherein the door is pivotally coupled to the body and configured to rotate about an axis of rotation that extends laterally.

2. The vehicle of claim 1, wherein the body includes a cab configured to contain at least one operator and a windshield permitting a line of sight out of the cab, wherein the recess is positioned below the windshield.

3. The vehicle of claim 2, further comprising a first headlight and second headlight coupled to the cab and laterally offset from one another, wherein the recess is positioned between the first headlight and the second headlight.

4. The vehicle of claim 1, further comprising:
a tractive element coupled to the chassis;
an electric motor coupled to the tractive element; and
a battery coupled to the chassis and configured to supply electrical energy to the electric motor to propel the vehicle,
wherein the port is a charging port configured to selectively couple to an external power source to charge the battery.

5. The vehicle of claim 1, wherein the door extends above the recess when the door is in the open position.

6. The vehicle of claim 1, wherein the door extends below the recess when the door is in the open position.

7. The vehicle of claim 1, wherein the axis of rotation is a first axis of rotation, further comprising a biasing member pivotally coupled to the body and to the hinge member, wherein the biasing member is rotatable relative to the hinge member about a second axis of rotation, and wherein the recess extends between the first axis of rotation and the second axis of rotation.

8. The vehicle of claim 7, wherein the biasing member is a gas spring configured to apply a biasing force on the hinge member that causes rotation of the door about the first axis of rotation.

9. The vehicle of claim 1, further comprising a biasing member pivotally coupled to the body and to the door, wherein the biasing member is configured to apply a biasing force on the door that causes rotation of the door about the axis of rotation.

10. The vehicle of claim 1, wherein the door is further repositionable into a middle position between the open position and the closed position, further comprising a stop configured to hold the door in the middle position, and wherein the stop is configured to release the door from the middle position in response to a user applying a force on the door.

11. A vehicle comprising:
a chassis;
a body coupled to the chassis and having a front surface, the body defining a recess positioned along the front surface and extending rearward from the front surface;
a port coupled to the body and positioned within the recess;
a door movably coupled to the body and selectively repositionable between a closed position and an open position, wherein the door is pivotally coupled to the body and configures to rotate about an axis of rotation that extends laterally; and
a biasing member pivotally coupled to the body and to the door,
wherein the biasing member is configured to apply a biasing force on the door that causes rotation of the door about the axis of rotation,
wherein, in the closed position, the door extends across the recess and obstructs access to the port,
wherein, in the open position, the door permits access to the port,
wherein the door is further repositionable into a transition position between the open position and the closed position,
wherein the biasing member is configured to bias the door toward the closed position when the door is between the transition position and the closed position, and
wherein the biasing member is configured to bias the door toward the open position when the door is between the transition position and the open position.

12. The vehicle of claim 11, further comprising a stop configured to hold the door in a charging position between the open position and the closed position, and wherein the stop is configured to release the door in response to a user applying a force on the door.

13. The vehicle of claim 12, wherein the biasing member is configured to bias the door toward the open position when the door is in the charging position.

14. The vehicle of claim 11, wherein the biasing member extends within the recess.

15. The vehicle of claim 11, further comprising:
a panel coupled to the body, extending along the front surface, and having an edge that at least partially defines the recess; and
a hinge member pivotally coupling the door to the body, wherein the hinge member defines a swing recess that receives the edge when the door is in the open position.
